(19) United States
(12) Patent Application Publication
(10) Pub. No.: US 2006/0186135 A1
(43) Pub. Date: Aug. 24, 2006

(54) Novelty dispensers and methods thereof

(76) Inventors: Gary D. Rose, North Las Vegas, NV (US); Shawna Rose, North Las Vegas, NV (US)

Correspondence Address: DAVID LANDMAN, PH.D., 1617 CARDINAL BLUFF DR., # 202, LAS VEGAS, NV, 89128, US

(21) Appl. No.: 11/338,959

(22) Filed: Jan. 25, 2006

Related U.S. Application Data
(60) Provisional application No. 60/654,808, filed on Feb. 22, 2005.

(51) Int. Cl. B05B 11/00; B67D 5/64

(52) U.S. Cl. 222/78; 222/175; 222/494; 222/215

(57) ABSTRACT

A novelty dispenser containing a sanitizer fluid for use by children is disclosed. The novelty dispenser has a substantially hollow housing configured to receive a sanitizer fluid. When an outer portion of the housing is squeezed by a child, a measured portion of the sanitizer fluid is dispensed from a valve of the novelty dispenser. The novelty dispenser may be any type of toy that is of interest to children. The novelty dispenser may be coupled to a break-away necklace or a belt clip for display by the child. Display and use of the novelty dispenser encourages hygienic behavior by the child and other children. When the novelty dispenser is empty of sanitizer fluid, the novelty dispenser may be retained and collected as a toy. More than one novelty dispenser having different shapes may be packaged in a container as a kit.

### CROSS-REFERENCE TO RELATED APPLICATION

This application claims priority to a corresponding provisional application U.S. Ser. No. 60/654,808, filed Mar. 10, 2005 in the name of the applicants of this application.

### FIELD OF THE INVENTION

This invention relates to dispensers, and more specifically, to novelty collectable sanitizer dispensers configured for facile and safe use by children and methods thereof.

### BACKGROUND OF THE INVENTION

In the past, numerous dispensers suitable for use by adults for dispensing various antibacterial or antimicrobial solutions have been marketed. Such dispensers typically assume that an adult has the tactile ability to easily obtain the benefit of an antibacterial or antimicrobial product in a container. In one common example a deformable tube requires removal of a screw-on cap to access a topically active material. Manufacturers of such dispensers assume that such products are not used by children directly, but rather that an adult will dispense the topically active material for application to a child's wound by a supervising adult.

Often adults have difficulty in training children to practice hygiene. In their younger years children are prone to various bacterial and viral diseases because they have undeveloped immune system and subsequently less resistance to diseases. Additionally, children are generally less hygienic and are exposed to a variety of environments such as playing with many other children at school and during other community activities. While playing, children often do not think about how threatening their environment may be to their health, especially in terms of remaining clean by practicing hygiene.

Adults may not always be present to supervise children. Even hygienically well-trained children may not have easy access to facilities for washing their hands or applying any kind of dispensers and wipes suitable for cleaning their hands.

### SUMMARY OF THE INVENTION

For the foregoing reasons, there is a need to provide improved sanitizer dispensers that may be easily carried by children for convenient use. Such dispensers should be easy to use and pose no risk to children such as choking when carried on a necklace around a child's neck. Children should be motivated to use such improved dispensers and perceive them as an indispensable fun tool to keep them hygienic.

Accordingly, it is an object of this invention to provide an improved sanitizing dispenser suitable for facile use by a child.

It is a further object of this invention to provide an improved sanitizing dispenser that does not require a water source for use by a child.

It is a yet further object of this invention to provide an improved sanitizing dispenser configured for safe use by a child.

It is a further object of this invention to provide an improved sanitizing dispenser suitable for easy transportation by a child.

It is a still further object of this invention to provide novel collectable sanitizing dispensers for children.

It is a further object of this invention to provide a method for using improved sanitizing dispensers by children.

### PREFERRED EMBODIMENTS OF THE INVENTION

In accordance with an embodiment of this invention, a novelty dispenser is disclosed. The novelty dispenser comprises, in combination, a housing having an inner portion configured to receive a sanitizer fluid. Furthermore, an outer portion of the housing comprises a transport device configured to facilitate display of the novelty dispenser. The housing includes a valve configured to dispense a portion of the sanitizer fluid from the inner portion when an outer portion of the housing is squeezed thereby encouraging hygienic behavior.

A portion of the novelty dispenser may comprise a substantially see-through indicator to permit observation of the level of the sanitizer fluid. The transport device comprises a break-away necklace having a substantially concave shaped end configured to receive a second substantially convex shaped end of the break-away necklace. A pull force of about two pounds decouples the convex shaped end from the concave shaped end to prevent choking when wearing the break-away necklace.

The sanitizer fluid comprises at least one non-toxic antibacterial component and may further comprise at least one of the following: a non-toxic colorant, a non-toxic scent, an emollient and a non-toxic sour tasting component to discourage ingestion of the sanitizer fluid.

In accordance with another embodiment of this invention, a method to encourage hygienic behavior is disclosed. The method comprises the steps of providing a novelty dispenser including a housing configured to receive a sanitizer fluid and wearing and displaying the novelty dispenser. In a further step an outer portion of the housing is squeezed to dispense a portion of the sanitizer fluid out of a valve of the novelty dispenser onto at least one hand of a person and the sanitizer is rubbed in a washing pattern between each hand of the person. In yet another step the novelty dispenser may be retained after all of the sanitizer fluid has been dispensed out of the housing and each novelty dispenser of a plurality of novelty dispensers may be collected.

In accordance with another embodiment of this invention, a novelty dispenser kit is disclosed. The kit comprises, in combination, a plurality of novelty dispensers, each novelty dispenser of the plurality of novelty dispensers including a housing configured to receive a sanitizer fluid. An outer portion of the housing comprises a transport device configured to facilitate display of the novelty dispenser. The housing includes a valve configured to dispense a portion of the sanitizer fluid when an outer portion of the housing is squeezed thereby encouraging hygienic behavior. At least one novelty dispenser of the plurality of novelty dispensers is packaged in a container.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a perspective view showing a front side of a novelty dispenser in accordance with an embodiment of this invention.

FIG. 1A is a sectional view through 1A-1A of an inner portion of the dispenser of FIG. 1.

FIG. 1B is an enlarged view of an inner portion of an end of the dispenser of FIG. 1.

FIG. 1C is a perspective view showing an enlarged view of an outer portion of an end of the dispenser of FIG. 1.

FIG. 1D is a perspective view depicting a valve of the dispenser of FIG. 1 in a closed position.

FIG. 1E is a perspective view depicting a valve of the dispenser of FIG. 1 in an open position.

FIG. 2 is a perspective view of a front side of another embodiment of a novelty dispenser coupled to a portion of a necklace.

FIG. 3 is a perspective view of a front side of yet another embodiment of a novelty dispenser coupled to a portion of a clip.

FIG. 3A is an enlarged view of the clip of FIG. 3.

FIG. 4A is a perspective view of the embodiment of the dispenser of FIG. 3 in use by a female child.

FIG. 4B is a perspective view of another embodiment of a dispenser in use by a male child.

FIG. 5 is a perspective view of different embodiments of dispensers and accessories configured as kits in two separate containers.

### DESCRIPTION OF THE INVENTION

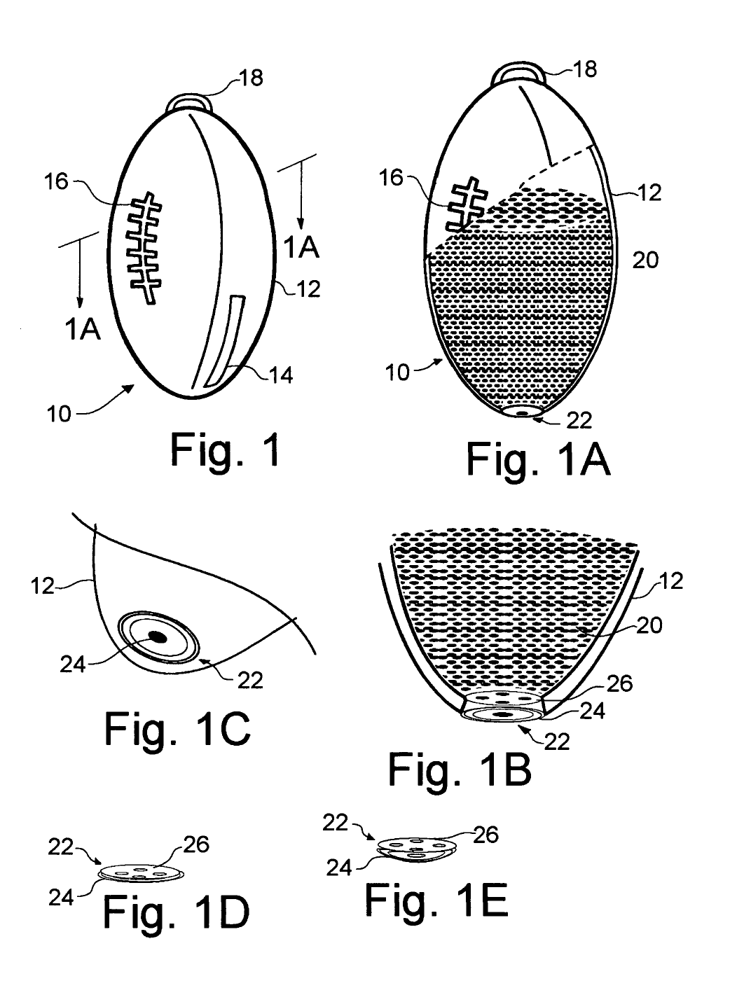

Referring to FIG. 1, in one embodiment of a novelty dispenser 10 suitable for use and collection by a child, a housing 12 of the dispenser generally has a football shape which would be of greater interest to a boy. Of course, the novelty dispenser 10 may have any suitable novel shape that would be of interest to any child. A child may be any young person. In one embodiment a child may be from five to fifteen years old, but of course there is no limitation as to the age of a person who may use the novelty dispenser of this disclosure.

In an embodiment of the novelty dispenser 10, the dispenser may comprise a pliant or semi-rigid polymer having the shape, design and color of a toy. Pliant polymers may be any suitable plastic including polyolefins such as polyethylene, polypropylene, polyesters such as polyethylene terephthalate, polyvinyl halides such as polyvinyl chloride, polyamides such as nylon and the like as is understood in the art.

As shown in the exemplary embodiment of the novelty dispenser 10 of FIG. 1, the dispenser may comprise a substantially see-through (transparent or translucent) indicator (or gauge) 14 configured to permit observation by a child or an adult of the level of a fluid 20 (see FIG. 1A and the description below) within the dispenser. A lace-like outer portion 16 of the football-shaped dispenser 10 may be opaque or substantially see-through and may also be configured as a fluid level indicator.

An outer portion of the housing 12 may comprise a loop 18 having an opening (or a protuberance 18 having a slot-like appearance). The loop 18 may be a portion of a clip which permits direct coupling of the novelty dispenser 10 to a child's clothing or any object carried by the child such as a back-pack. The loop 18 may be contiguous with an outer portion of the housing 12 or may be configured as a removable appendage (not shown). When configured as a removable appendage, a portion of the loop 18 may function as a cap (screw-on, plug and the like) to close an opening of the novelty dispenser 10. The fluid 20 may be dispensed into an inner portion of the novelty dispenser 10 through the opening configured to receive a portion of the loop 18. Of course, the housing 12 may have another opening and closure mechanism in addition to or in place of the above-described cap of the loop 18. For example, the novelty dispenser 10 may be configured as two or more portions that may be coupled by a screw thread arrangement or any other coupling mechanism as is well understood in the art. When one of the portions of the novelty dispenser 10 is separated from another portion, the fluid 20 may be dispensed into an inner portion of the novelty dispenser to refill the novelty dispenser.

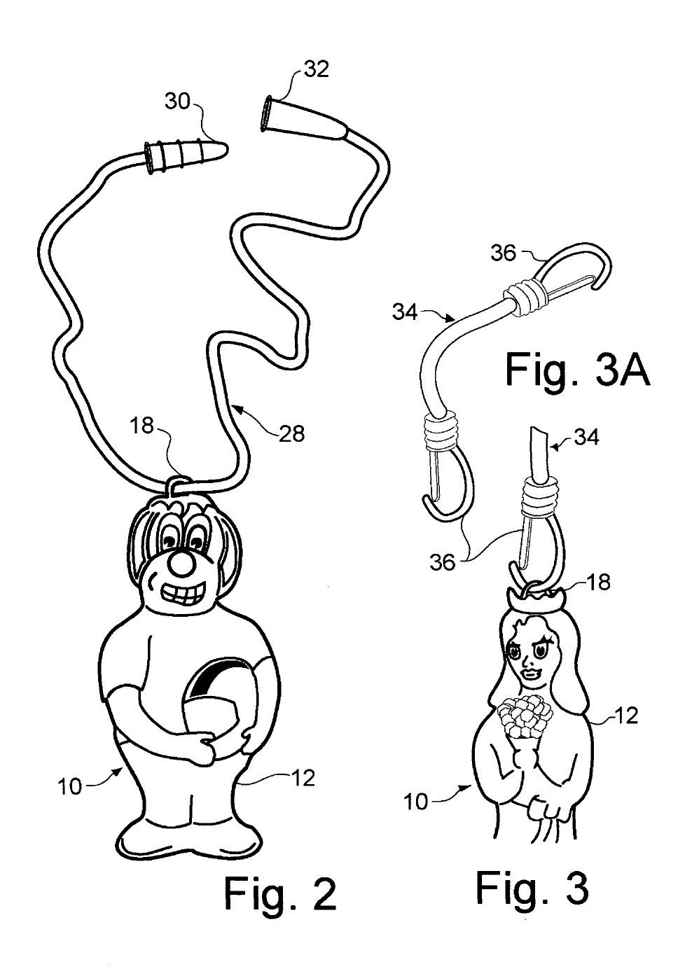

The loop 18 may also be conveniently coupled to a necklace, a bracelet, a band, a ribbon, a belt clip, a belt, a strap or any other fastener and the like (see FIG. 2 and the description below) to provide a transport device. An advantage of such a transport device is that a child may conveniently display and transport the novelty dispenser 10. It is understood that any one of the necklace, band, ribbon, belt clip, strap or any other fastener and the like may be configured as a transportation device coupled to an outer portion of the housing 12.

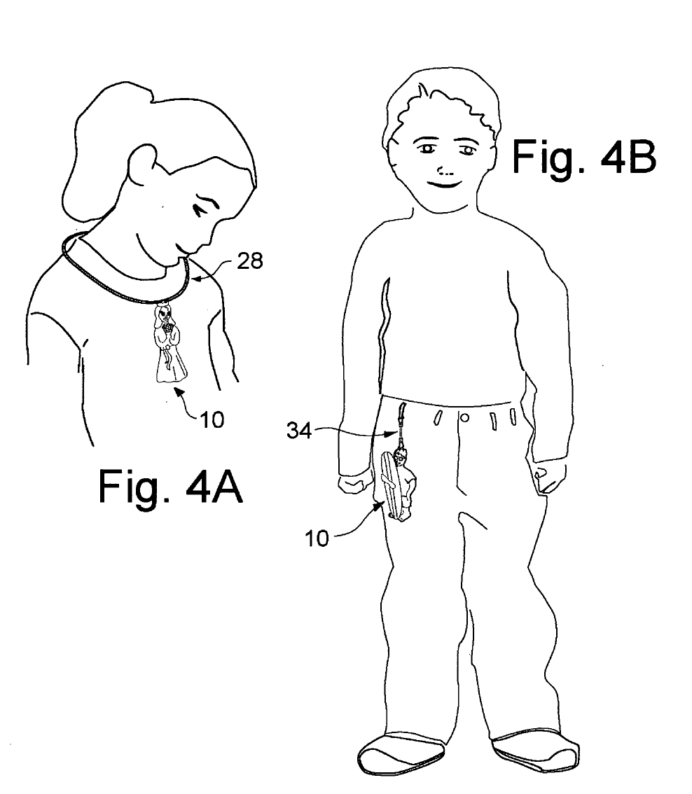

Without limiting the scope of the invention a child may display the novelty dispenser 10 in a variety of ways including as jewelry, a toy, a collector's item and the like (see FIGS. 4A and 4B, and description below). Of course, since the novelty dispenser 10 may be sized to any suitable dimension, the loop 18 may be configured as a ring suitable for use by a child.

Referring now to FIG. 1A, a sectional view through 1A-1A of the football shaped dispenser 10 of FIG. 1 shows an inner portion of the novelty dispenser. The inner portion of the novelty dispenser 10 may be substantially hollow and filled with the fluid 20. In one embodiment, the fluid 20 may be placed in a separate cartridge to be inserted in a portion of the inner portion of the novelty dispenser 10.

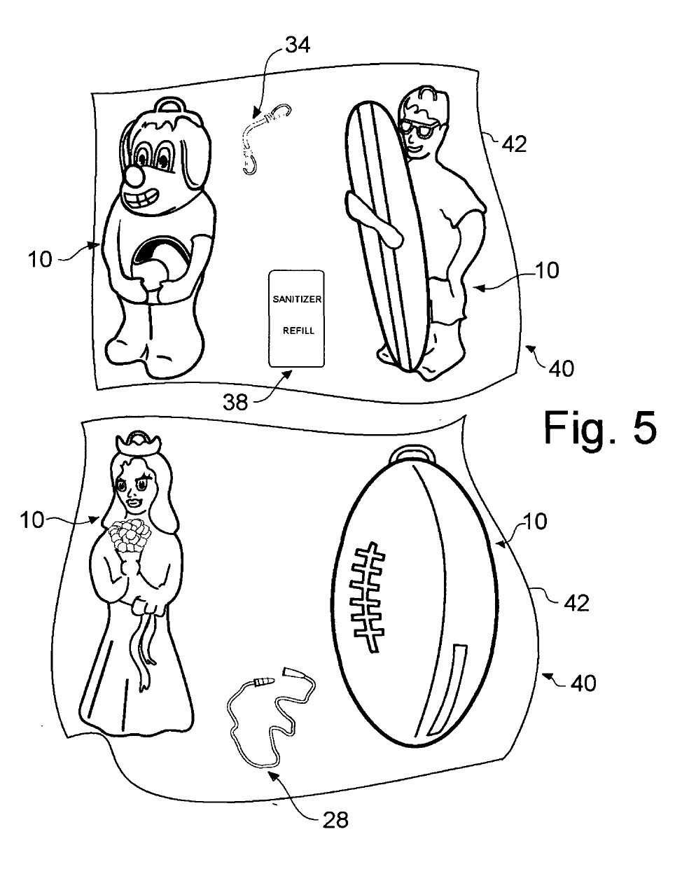

Additionally, a portion of the novelty dispenser 10 comprises a valve 22 (see FIGS. 1B, 1C, 1D and 1E and the description below) having an aperture suitable for dispensing the fluid 20 from the inner portion of the novelty dispenser. In FIG. 1A, the valve 22 is located at one end of the football shaped dispenser 10. It is understood that the valve 22 may be on any portion of the novelty dispenser 10 (such as a foot, a hand or a dress) of a novelty character as shown in FIG. 5 and described below.

The fluid 20 in the novelty dispenser 10 may be any type of sanitizer (sanitizing lotion) suitable for use by a child to encourage more hygienic behavior. In one embodiment, the sanitizer may be a mild gel-like formulation in ethyl alcohol which may be a principal active ingredient. In an exemplary embodiment, the sanitizer comprises non-toxic antibacterial and/or antimicrobial agents including various active components. Without limiting the scope of the invention, examples of active components include chlorhexidene gluconate, alcohols such as ethyl and propyl alcohol and/or triclosan. Triclosan (CAS No: 3380-34-5) consists of the chemical formula: 2,4,4′-Trichloro-2′-hydroxydiphenyl ether available from numerous manufacturers, one example of a manufacturer being Decon Laboratories, PA, U.S.A. Additionally, an emollient may be included as a component of the sanitizer to counter any dryness of the skin caused by using of the above-described active components. Of course the sanitizer may also include suitable non-toxic colorants, suitable non-toxic scents and optionally various amounts of water. Furthermore, one or more non-toxic sour tasting components may be added to the sanitizer to discourage ingestion of the sanitizer by a child.

In operation, when needed to clean a child's hands, a child may squeeze a portion of the novelty dispenser 10 to force out a measured amount of the sanitizer out of the dispenser. Since in one embodiment the sanitizer is formulated as a fluid, no extra source of water is required. Consequently, there is no restriction in time or place of use of the novelty dispenser 10. Once the sanitizer is expelled into a child's hand, the child simply rubs his or her hands together in a washing like pattern. Therefore, the novelty dispenser 10 would encourage sanitary behavior by the child and be regarded as a child-friendly companion. Furthermore, other children would observe this hygienic behavior and desire to emulate this behavior. As an added benefit, since the dispenser 10 is a novelty, children would be motivated to collect such dispensers after all the sanitizer had been dispensed out. Parents of children would also benefit since their children would require less hygiene training. It is contemplated that the novelty dispenser 10 (containing a sanitizer) may be used in various promotional formats, including commercial as well as non-profit health campaigns.

Referring now to FIG. 1B, an enlarged view of the valve 22 is shown in an open position such as when a portion of the housing 12 of the novelty dispenser 10 is squeezed to dispense the fluid 20. The valve 22 comprises an outer valve portion 24 having a substantially centrally located aperture and an inner valve portion 26 having a plurality of openings substantially located on a periphery of the inner valve portion. According to FIG. 1B, when an outer portion of the novelty dispenser 10 is squeezed, the outer valve portion 24 and the inner valve portion 26 may be sufficiently separated so that the fluid 20 may pass through the inner valve portion's openings and from there through the outer valve portion's aperture. In an exemplary embodiment the novelty dispenser 10 including a pre-filled sanitizing lotion (fluid 20) may be compressed to dispense the sanitizer through a cross-hair aperture of about three-eighths-of-one-inch (⅜″) diameter. Of course, the aperture may be any suitable size depending on the functionality of the valve 22 with respect to the fluid 20.

FIG. 1C shows an enlarged view of the outer valve portion 24 including an aperture. FIG. 1D depicts the valve 22 in a closed position with the inner valve portion 24 and the outer valve portion 26 close enough to one another to prevent flow of the fluid 20 when the novelty dispenser 10 is uncompressed. It is understood that both inner valve portion 24 and outer valve portion 26 conform to each other when the novelty dispenser 10 is uncompressed.

FIG. 1E depicts the valve 22 in an open position with the inner valve portion 24 and the outer valve portion 26 separated to allow flow of the fluid 20 when the novelty dispenser 10 is compressed. The valve 22 may comprise any suitable semi-rigid material such as polyethylene or any other polymer as is well understood in the art.

FIG. 2 illustrates yet another embodiment of a novelty dispenser 10 comprising a footballer shaped dispenser. The footballer dispenser 10 comprises a loop 18 with a break-away necklace 28 passing through the loop. It is understood that the necklace 28 may be attached directly to a portion of the surface of the novelty dispenser 10 rather than passing through the loop 18.

In one embodiment, the necklace 28 has a substantially convex shaped end 30 comprising a substantially ridged surface and a corresponding substantially concave shaped end 32 configured to receive the convex shaped end. Of course, each end of the necklace 28 may be coupled (connected) in any suitable manner. In an exemplary embodiment of a safety feature to prevent choking of a child wearing the novelty dispenser 10 attached to the break-away necklace 28, a force of up to about two pounds (2 lbs.) may be sufficient to decouple the convex shaped end 30 from the concave shaped end 32 of the necklace. Of course, the pull force necessary for opening the break-away necklace 28 is a design feature of the necklace.

While the necklace 28 may be any length, in one embodiment, a preferred length of the necklace may be about 10 inches. The necklace 28 may comprise any material as is well understood in the art. In an exemplary embodiment the necklace 28 comprises a plastic such as polyethylene and the like.

FIG. 3 illustrates yet another embodiment of the novelty dispenser 10 comprising a doll shaped dispenser which may be of greater interest to a girl. The doll shaped dispenser 10 may also include the loop 18 configured to receive an end connector 36 of a quick-connect belt clip 34 (shown in partial view). FIG. 3A illustrates the quick-connect belt clip 34 comprising an end connector 36 at each end of the belt clip. Of course, the end connector 36 at each end of the belt clip 34 need not be the same. For example, the end connector 36 may be a clasp, a hook, a press-stud or any other suitable fastener and the like.

Of course, without limiting the scope of the invention, each novelty dispenser 10 as illustrated in both FIGS. 2 and 4 may comprise similar features as described above for the football shaped dispenser of FIG. 1, such as the substantially see-through (indicator (or gauge) 14, the valve 22 and the sanitizer fluid 20 dispensed through an aperture of the valve. Each novelty dispenser 10 (illustrated in FIGS. 2 and 3) may comprise a pliant polymeric material from which the sanitizer fluid 20 may be dispensed when squeezed by a child.

FIG. 4A illustrates an exemplary embodiment showing how the doll shaped dispenser 10 is displayed by a girl wearing the dispenser coupled to the break-away necklace 28. Apart from being a display item, when the girl needs to clean her hands, the doll shaped dispenser 10 may be squeezed and a measured quantity of sanitizer may be dispensed as described above. Other girls seeing the doll shaped dispenser 10 may be motivated to emulate the girl displaying the doll shaped dispenser and therefore practice improved hygienic behavior. When the dispenser 10 is empty, the doll shaped character may still be retained as a decorative item to be collected and worn as desired. Of course the break-away necklace 28 may be sized to fit around a child's wrist or around a child's waist. When configured as a wrist bracelet (strap) or as a belt, the force required to open the bracelet or the belt may be increased.

FIG. 4B illustrates an exemplary embodiment showing how yet another novelty dispenser 10 shaped as a surf boarder shaped dispenser is worn by a boy using the belt clip 34. One end of the belt clip 34 may coupled to a portion of the surf boarder shaped dispenser 10, while an end connector 36 at an opposite end of the belt clip 34 may be coupled to a belt loop on the boy's trousers. It is understood that the end connector 36 may be coupled to any item worn by either a boy or a girl such as a backpack configured with any type of loop or ring (not shown).

Since each novelty dispenser 10 may be desired by children as collector's pieces, in one embodiment, one or more dispensers may be made available as a kit 40 for purchase. FIG. 5 illustrates an embodiment of two kits 40, with each kit comprising two different novelty dispensers 10 in two separate containers 42. In one kit 40, the novelty dispensers 10 comprise the footballer shaped dispenser (see FIG. 2 and description above) and the surf boarder shaped dispenser (see FIG. 4B and above) including a belt clip 34 and a sanitizer refill module 38. This version of the kit 40 may be of greater interest to a boy. Parents wishing to encourage hygienic behavior may present a boy with this version of the kit 40 and further instill other behavioral traits such as collecting and pride of ownership.

In yet another version of the kit 40 further illustrated in FIG. 5, the kit may comprise the doll shaped dispenser 10 (see FIG. 3 and description above) and the football shaped dispenser 10 (see FIG. 1 and description above) together with a break-away necklace 28 in a suitable container 42. In this version of the kit 10, the novelty dispensers 10 may be presented as a gift to a family having both a boy and a girl. Of course, the kit 40 may comprise any number of novelty dispensers 10 (as well as any other suitable objects, such as refill sanitizer modules, breakaway necklaces, belt clips and the like) in a container 42. Furthermore, each novelty dispenser 10 of a group of novelty dispensers may be packaged in a separate container and the prepackaged novelty dispensers may be further packed in an outer container.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A novelty dispenser comprising, in combination:
a housing having an inner portion configured to receive a sanitizer fluid;
an outer portion of said housing comprising a transport device configured to facilitate display of the novelty dispenser;
said housing including a valve configured to dispense a portion of said sanitizer fluid from said inner portion when an outer portion of said housing is squeezed thereby encouraging hygienic behavior.

2. The novelty dispenser according to claim 1 wherein said housing has a collectable toy shape of interest to a person.

3. The novelty dispenser according to claim 2 wherein said collectable toy shape is selected from the group consisting of a football, a footballer, a surf boarder and a doll.

4. The novelty dispenser according to claim 1 further comprising a substantially see-through indicator thereby permitting observation of the level of said sanitizer fluid.

5. The novelty dispenser according to claim 1 wherein said transport device comprises a break-away necklace having a substantially concave shaped end configured to receive a second substantially convex shaped end of said break-away necklace.

6. The novelty dispenser according to claim 5 wherein a pull force of up to about two pounds decouples said convex shaped end from said concave shaped end to prevent choking when wearing said break-away necklace.

7. The novelty dispenser according to claim 1 wherein said transport device comprises a belt clip configured to couple to attire.

8. The novelty dispenser according to claim 1 wherein said housing comprises a pliant polymer.

9. The novelty dispenser according to claim 8 wherein said pliant polymer is selected from the group consisting of polyolefin, polyester, polyvinyl halide and polyamide.

10. The novelty dispenser according to claim 1 wherein said sanitizer fluid comprises at least one non-toxic antibacterial component.

11. The novelty dispenser according to claim 10 wherein said non-toxic antibacterial component is selected from the group consisting of at least one of an alcohol, chlorhexidene gluconate, and triclosan.

12. The novelty dispenser according to claim 1 wherein said sanitizer fluid comprises at least one of the following: a non-toxic colorant, a non-toxic scent, an emollient and a non-toxic sour tasting component to discourage ingestion of said sanitizer fluid.

13. The novelty dispenser according to claim 1 wherein said valve comprises an outer valve portion having an aperture and an inner valve portion comprising a plurality of openings, said outer valve portion substantially conforming to said inner valve portion when said novelty dispenser is uncompressed and said outer valve portion separated from said inner valve portion when said novelty is compressed thereby facilitating flow of said sanitizer fluid.

14. A method to encourage hygienic behavior comprising the steps of:
providing a novelty dispenser including a housing configured to receive a sanitizer fluid;
wearing and displaying said novelty dispenser;
squeezing an outer portion of said housing to dispense a portion of said sanitizer fluid out of a valve of said novelty dispenser onto at least one hand of a person; and
rubbing the sanitizer in a washing pattern between each hand of said person.

15. The method according to claim 14 further comprising the steps of:
coupling a portion of said novelty dispenser to at least one of a break-away necklace and a belt clip; and
motivating others to practice hygiene when said novelty dispenser is displayed and used.

16. The method according to claim 14 further comprising the steps of:
retaining said novelty dispenser after all of said sanitizer fluid has been dispensed out of said housing; and
collecting each novelty dispenser of a plurality of novelty dispensers.

17. A novelty dispenser kit comprising, in combination:
a plurality of novelty dispensers, each novelty dispenser of said plurality of novelty dispensers including a housing configured to receive a sanitizer fluid;
an outer portion of said housing comprising a transport device configured to facilitate display of the novelty dispenser;
said housing including a valve configured to dispense a portion of said sanitizer fluid when an outer portion of said housing is squeezed thereby encouraging hygienic behavior; and
at least one novelty dispenser of said plurality of novelty dispensers packaged in a container.

18. The kit according to claim 17 wherein each of said plurality of novelty dispensers comprises a collectable toy shaped housing.

19. The kit according to claim 17 further comprising at least one of a break-away necklace, a belt clip and a sanitizer refill module in said container.
